(19) United States
(12) Patent Application Publication
(10) Pub. No.: US 2005/0078584 A1
(43) Pub. Date: Apr. 14, 2005

(54) System and method for error correction in optical disk system

(75) Inventor: Hsin-Lung Yang, Hsinchu (TW)

Correspondence Address: Finnegan, Henderson, Farabow,;Garrett & Dunner, L.L.P., 1300 I Street, N.W., Washington, DC, 20005-3315, US

(73) Assignee: Cheertek, Inc.

(21) Appl. No.: 10/681,097

(22) Filed: Oct. 9, 2003

(51) Int. Cl. G11B 7/00

(52) U.S. Cl. 369/53.35

(57) ABSTRACT

A system for error correction that comprises a servo device receiving data sent from an optical pickup head and determining whether the data include a first error, a read channel determining whether the data include a second error, a demodulator determining whether the data include a third error, and a controller marking the data with a flag if it is determined that the data include the first, second, or third error.

### DESCRIPTION OF THE INVENTION

1. Field of the Invention

This invention relates in general to error correction in an optical disc reproduction system and, more particularly, to systems and methods of providing an erasure signal in an optical disc reproduction system.

### BACKGROUND OF THE INVENTION

An optical disc reproduction system generally includes an optical pickup head, a read channel, a servo controller, a demodulator, and an error correction code (“ECC”) decoder. The optical pickup head reads data from or writes data to an optical storage medium such as a compact disc (“CD”) or a digital video disc (“DVD”) by applying laser beams to the surface of the optical storage medium. A preamplifier is typically provided to amplify an output signal of the optical pickup head and generates a reproduction radio frequency (“RF”) signal. The read channel converts the RF signal into a bit string. The servo controller detects the RF signal and generates error signals for servo control. The demodulator is coupled to the read channel for demodulating an output signal of the read channel. The ECC decoder decodes the demodulated signals sent from the demodulator, and performs error correction for the demodulated signals. The number of errors correctable depends on the maximum processing capability of the ECC. Errors exceeding the limit of the ECC cannot be corrected. Therefore, there can be data errors which are not corrected by the ECC.

The ECC decoder may include a first stage and a second stage for performing the error correction. For CDs, the first and second stages may be termed C₁ and C₂, respectively. For DVDs, the first and second stages may be termed PI and PO, respectively. Typically, C₁ or PI performs an error correction prior to C₂ or PO, but may not correct as many errors as C₂ or PO. Assuming that data include a total number of N errors, N being an integral, C₁ or PI may correct N/2 errors, and C₂ or PO may correct N/2 errors or N erasures, in which an error represents a condition where a position and a value of erroneous data are unknown and both need to be calculated, and an erasure represents a condition where a position is known and a value is unknown. In conventional technologies in the art, the erasure signal, which enables C₂ or PO more efficient in error correction than C, or PI, may not appear until completion of C₁ or PI.

To enhance the ability of an ECC decoder in error correction, it is thus desirable to provide an erasure signal to an ECC decoder, specifically the C₁ or PI stages of the ECC decoder, when erroneous data are sent to the ECC decoder.

### SUMMARY OF THE INVENTION

Accordingly, the present invention is directed to a backlight assembly that obviates one or more of the problems due to limitations and disadvantages of the related art.

To achieve these and other advantages, and in accordance with the purpose of the invention as embodied and broadly described, there is provided a system for error correction that comprises a servo device receiving data sent from an optical pickup head and determining whether the data include a first error, a read channel determining whether the data include a second error, a demodulator determining whether the data include a third error, and a controller marking the data with a flag if it is determined that the data include the first, second, or third error.

In one aspect, the controller provides the flag when the data including the first, second or third error are sent to an error correction code (ECC) decoder.

Also in accordance with the present invention, there is provided a system for error correction that comprises an optical pickup head generating data by scanning an optical storage medium, a servo device determining whether the data include a first error, a read channel determining whether the data include a second error, a demodulator determining whether the data include a third error, an error correction code (ECC) decoder including a first stage and a second stage for correcting the data, and a controller providing a flag corresponding to the data when the data are sent to the first stage of the ECC decoder if it is determined that the data include the first, second, or third error.

In one aspect, the read channel further comprises a slicer-type and a PRML-type (partial response maximum likelihood) read channel.

Still in accordance with the present invention, there is provided a method of error correction in an optical disc reproduction system including a servo device, a read channel and a demodulator that comprises providing data generated by an optical pickup head, determining in the servo device whether the data include a first error, determining in the read channel whether the data include a second error, determining in the demodulator whether the data include a third error, and marking the data with a flag if it is determined that the data include the first, second, or third error.

Yet still in accordance with the present invention, there is provided a method of providing an erasure signal to an error correction code (ECC) decoder that comprises determining in a servo device whether data sent from an optical pickup head include a first error, determining in a read channel whether the data include a second error, determining in a demodulator whether the data include a third error, providing a signal indicating that the data include an error if it is determined that the data include the first, second, or third error, and generating in response to the signal an erasure signal corresponding to the data when the data are sent to the ECC decoder.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a block diagram of a system for error correction in accordance with one embodiment of the present invention; and

FIG. 2 is a flow diagram illustrating a method of error correction in accordance with one embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

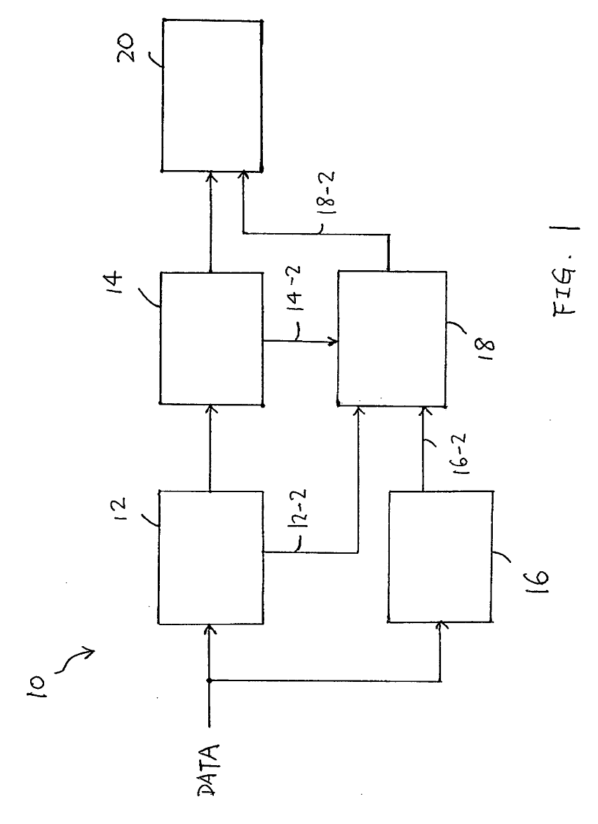

FIG. 1 is a block diagram of a system 10 for error correction in accordance with one embodiment of the present invention. Referring to FIG. 1, system 10 includes a read channel 12, a demodulator 14, a servo device 16, and a controller 18, and an error correction code (“ECC”) decoder 20. Read channel 12 receives data generated by an optical pickup head (not shown) by scanning the surface of an optical storage medium (not shown) such as a compact disc (“CD”) or a digital video disc (“DVD”). Different types of CDs that constitute a CD family may include CD-ROM for read-only, CD-DA for audio, CD-R for write-once and CD-RW for rewritable. Similarly, different types of DVDs may constitute a DVD family.

The data sent from the optical pickup head may include radio frequency (“RF”) signals. In one embodiment according to the present invention, read channel 12 includes a slicer-type read channel which may further include an RF amplifier (not shown) for adjusting an amplitude of the data reproduction signal to have a constant amplitude, and an equalizer (not shown) for improving frequency characteristics of the output signal of the RF amplifier. In another embodiment, read channel 12 includes a partial response maximum likelihood or PRML read channel which may further include a digital adaptive equalizer (not shown) for performing a predetermined partial response (PR) equalization, and a Viterbi decoder (not shown) for generating most likelihood (ML) binary data.

Read channel 12 determines whether the data sent from the optical pickup head include an error. For example, the PRML-type read channel including a Viterbi decoder may use a method of majority vote to observe outputs of all survivor paths and choose the majority as a decoded output. Errors can be found in read channel 12 if not all of the survivor paths give the same output value, or the number of paths for giving a logical “1” and “0” is almost the same. If an error is determined, read channel 12 provides via a line 12-2 to controller 18 a signal indicating that the data being processed in read channel 12 include an error. Since the error is located, in response to the signal sent from read channel 12, controller 18 marks the data with a flag, i.e., an erasure signal, when the data are processed down to ECC decoder 20.

Demodulator 14 is coupled to read channel 12 for demodulating an output signal of read channel 12. In one embodiment according to the present invention, demodulator 14 includes an eight-to-fourteen modulation (“EFM”) scheme used for CDs. In another embodiment, demodulator 14 includes an eight-to-sixteen modulation (“EFMPlus”) scheme used for DVDs. One symbol of data bits includes 8 bits for both the EFM and EFMPlus schemes, wherein one symbol of channel bits is 14-bit long for the EFM scheme, and 16-bit long for the EFMPlus scheme. As an example of the EFM modulation scheme, 8 data bits are encoded into 14 channel bits as one symbol. A mapping table for the EFM scheme contains selected code words in association with possible 256 data codes.

Demodulator 14 can detect an error of the data sent from read channel 12 during a mapping procedure. For example, a certain item included in the data is unmapped in the mapping table. If an error is determined, demodulator 14 provides via a line 14-2 to controller 18 a signal indicating that the data being processed in demodulator 14 include an error. Since the error is located, in response to the signal sent from demodulator 14, controller 18 marks the data with a flag when the data are processed down to ECC decoder 20.

Servo device 16 receives the data sent from the optical pickup head through, for example, a low pass filter (not shown). Servo device 16, which may be typically provided to generate error signals for servo control, determines whether the data include an error, for example, due to contamination on the surface or a non-reflected surface that would otherwise be reflected of an optical storage medium. Servo device 16 generates a defect signal in response to an error determined, and provides via a line 16-2 to controller 18 a signal indicating that the data include an error. Since the error is located, in response to the signal sent from servo device 16, controller 18 marks the data with a flag when the data are processed down to ECC decoder 20.

ECC decoder 20 may include a first stage and a second stage for error correction. In one embodiment, the first stage includes C₁ for CDs or PI for DVDs, and the second stage includes C₂ for CDs or PO for DVDs. Controller 18 calculates a latency between the time a signal is sent from line 12-2, 14-2, or 16-2 and the data reach ECC decoder 20, and provides via a line 18-2 the first stage of ECC decoder 20 with an erasure signal corresponding to the error data when the error data reach ECC decoder 20. The error correction efficiency of ECC decoder 20 is significantly optimized because the erasure signal is present at the first stage.

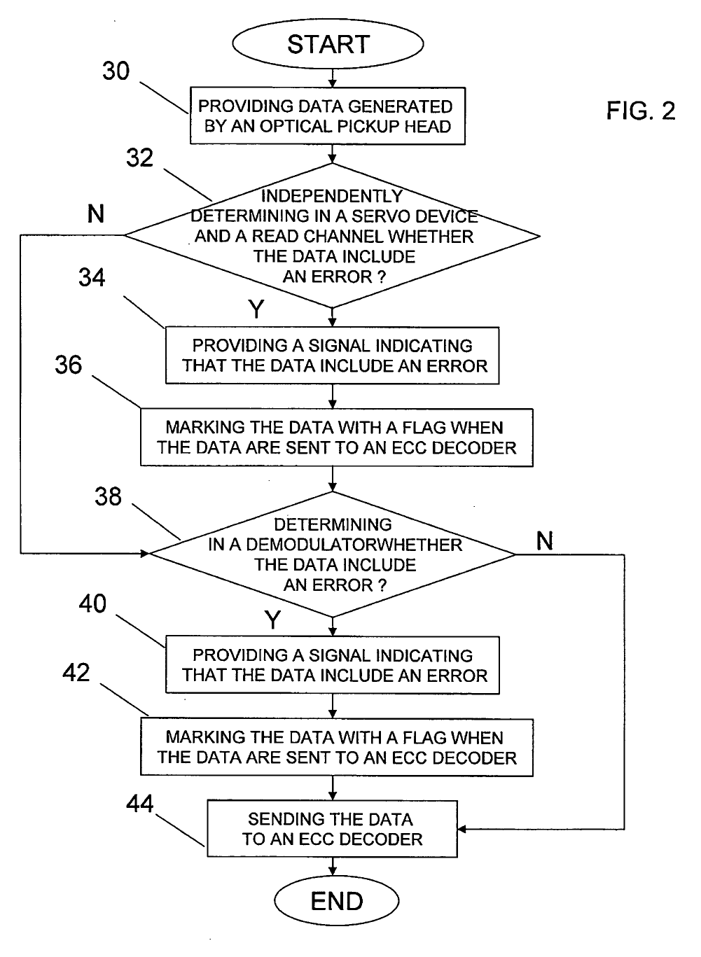

FIG. 2 is a flow diagram illustrating a method of error correction in an optical disc reproduction system 10 in accordance with one embodiment of the present invention. In step 30, data generated by an optical pickup head are provided to a read channel 12 and a servo device 16 of optical disc reproduction system 10. Next, in step 32, servo device 16 determines whether the data include a first error, for example, an error due to a contaminated optical medium. Also in step 32, read channel 12 determines whether the data include a second error, for example, an error related to majority vote. If the first error is determined, in step 34, servo device 16 provides a first signal to indicate that the data include an error. Similarly, if the second error is determined, in step 34, read channel 12 provides a second signal to indicate that the data include an error. Next, in step 36, the error data are marked with a flag by a controller 18 when the error data are sent to an ECC decoder 20.

Next, in step 38, demodulator 14 determines whether the data sent from read channel 12 include a third error, for example, a mapping error. If the third error is determined, in step 40, demodulator 14 provides a third signal to indicate that the data include an error. The error data are marked with a flag by controller 18 in step 42. The data, including errors or not, are later sent to ECC decoder 20 in step 44.

Error data sent to ECC decoder 20 are marked with a flag, which functions to serve as an erasure signal. Therefore, unlike conventional techniques that provide an erasure signal in an ECC decoder, the method in accordance with the present invention provides an erasure signal corresponding to the error data when the error data reach ECC decoder 20.

In one embodiment, the method further includes the step of providing a controller 18 for marking the error data with a flag in response to one of the first, second, or third signal.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for error correction comprising:
a servo device receiving data sent from an optical pickup head and determining whether the data include a first error;
a read channel determining whether the data include a second error;
a demodulator determining whether the data include a third error; and
a controller marking the data with a flag if it is determined that the data include the first, second, or third error.

2. The system of claim 1, the controller providing the flag when the data including the first, second or third error are sent to an error correction code (ECC) decoder.

3. The system of claim 1, the servo device providing a first signal to the controller if the first error is determined.

4. The system of claim 1, the read channel providing a second signal to the controller if the second error is determined.

5. The system of claim 1, the demodulator providing a third signal to the controller if the third error is determined.

6. The system of claim 1, the servo device determines the first error if a defect signal is generated.

7. The system of claim 1, the demodulator mapping the data sent from the read channel, and determining whether the data sent from the read channel include an unmapped item in determining the third error.

8. A system for error correction comprising:
an optical pickup head generating data by scanning an optical storage medium;
a servo device determining whether the data include a first error;
a read channel determining whether the data include a second error;
a demodulator determining whether the data include a third error;
an error correction code (ECC) decoder including a first stage and a second stage for correcting the data; and
a controller providing a flag corresponding to the data when the data are sent to the first stage of the ECC decoder if it is determined that the data include the first, second, or third error.

9. The system of claim 8, the optical storage medium further comprising a compact disc and a digital video disc.

10. The system of claim 8, the read channel further comprising a slicer-type and a PRML-type (partial response maximum likelihood) read channel.

11. A method of error correction in an optical disc reproduction system including a servo device, a read channel and a demodulator, comprising:
providing data generated by an optical pickup head;
determining in the servo device whether the data include a first error;
determining in the read channel whether the data include a second error;
determining in the demodulator whether the data include a third error; and
marking the data with a flag if it is determined that the data include the first, second, or third error.

12. The method of claim 11 further comprising providing a controller to provide the flag corresponding to the data when the data are sent to an error correction code (ECC) decoder.

13. The method of claim 11 further comprising providing a first signal to a controller for the first error.

14. The method of claim 11 further comprising providing a second signal to a controller for the second error.

15. The method of claim 11 further comprising providing a third signal to a controller for the third error.

16. The method of claim 11 further comprising determining whether the servo device generates a defect signal.

17. The method of claim 11 further comprising mapping the data sent from the read channel, and determining whether the data sent from the read channel include an unmapped item.

18. A method of providing an erasure signal to an error correction code (ECC) decoder, comprising:
determining in a servo device whether data sent from an optical pickup head include a first error;
determining in a read channel whether the data include a second error;
determining in a demodulator whether the data include a third error;
providing a signal indicating that the data include an error if it is determined that the data include the first, second, or third error; and
generating in response to the signal an erasure signal corresponding to the data when the data are sent to the ECC decoder.

19. The method of claim 18 further comprising providing a controller to mark the data with a flag when the data are sent to the ECC decoder.

20. The method of claim 18, wherein the step of determining in a servo device and the step of determining in a read channel are independently performed.
